(19) United States
(12) Patent Application Publication
(10) Pub. No.: US 2016/0202530 A1
(43) Pub. Date: Jul. 14, 2016

(54) PIXEL STRUCTURE OF LIQUID CRYSTAL DISPLAY PANEL AND PIXEL FORMING METHOD

(71) Applicants: HannStar Display (Nanjing) Corporation, Nanjing (CN); HANNSTAR DISPLAY CORPORATION, Taipei City (TW)

(72) Inventor: Szu-Yu Fang, Tainan City (TW)

(21) Appl. No.: 14/989,811

(22) Filed: Jan. 7, 2016

(30) Foreign Application Priority Data
Jan. 10, 2015 (CN) 201510013317.3

(51) Int. Cl. G02F 1/1339; G02F 1/1335

(52) U.S. Cl. CPC G02F 1/13394; G02F 1/133514; G02F 1/133512; G02B 5/201

(57) ABSTRACT

A pixel structure of a liquid crystal display panel includes a first substrate; a color filter layer formed on the first substrate, the color filter layer including a plurality of filtering areas for filtering light and a plurality of blocking areas for blocking light, the plurality of blocking areas including a first blocking area and a second blocking area; a covering layer formed on the first blocking area; a second substrate; a main spacer formed at a position on the second substrate corresponding to the first blocking area; and a sub spacer formed at a position on the second substrate corresponding to the second blocking area; wherein an end of the main spacer contacts the covering layer and a gap is formed between the sub spacer and the second blocking area.

### BACKGROUND OF THE INVENTION

1. Field of the Invention

The present invention relates to a pixel structure of a liquid crystal display panel and a pixel forming method, and more particularly, to a pixel structure and a pixel forming method capable of simplifying manufacturing processes of a liquid crystal display panel.

2. Description of the Prior Art

In manufacturing processes of a liquid crystal display panel, a plurality of main spacers and sub spacers are formed on an upper substrate or on a lower substrate of the liquid crystal display panel, in order to form a gap between the upper and lower substrates for filling liquid crystals. A top of the main spacer is configured to abut against the opposite substrate to provide support. A gap is formed between the sub spacer and the opposite substrate to provide a space for allowing deformation when the substrate is pressed by an external force. In the prior art, in order to form the main spacer and the sub spacer, a halftone mask process is used to accurately control exposure amount of different areas in order to make the sub spacer shorter than the main spacer. However, the halftone mask process has higher cost and is more complex, so as to further increase difficulty in product development of the liquid crystal display panel.

### SUMMARY OF THE INVENTION

The present invention provides a pixel structure of a liquid crystal display panel, comprising a first substrate; a color filter layer formed on the first substrate, the color filter layer comprising a plurality of filtering areas for filtering light and a plurality of blocking areas for blocking light, the plurality of blocking areas comprising a first blocking area and a second blocking area; a covering layer formed on the first blocking area; a second substrate; a main spacer formed at a position on the second substrate corresponding to the first blocking area; and a sub spacer formed at a position on the second substrate corresponding to the second blocking area; wherein an end of the main spacer contacts the covering layer, and a gap is formed between the sub spacer and the second blocking area.

The present invention further provides a pixel forming method of a liquid crystal display panel, comprising forming a color filter layer on a first substrate, the color filter layer comprising a plurality of filtering areas for filtering light and a plurality of blocking areas for blocking light, the plurality of blocking areas comprising a first blocking area and a second blocking area; forming a covering layer on the first blocking area; forming a main spacer at a position on a second substrate corresponding to the first blocking area and forming a sub spacer at a position on the second substrate corresponding to the second blocking area; and combining the first substrate with the second substrate; wherein an end of the main spacer contacts the covering layer, and a gap is formed between the sub spacer and the second blocking area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a pixel structure of a liquid crystal display panel of the present invention before assembly.

FIG. 2 is a diagram showing the pixel structure of the liquid crystal display panel of the present invention after assembly.

FIG. 3 is a flowchart showing a pixel forming method of the liquid crystal display panel of the present invention.

### DETAILED DESCRIPTION

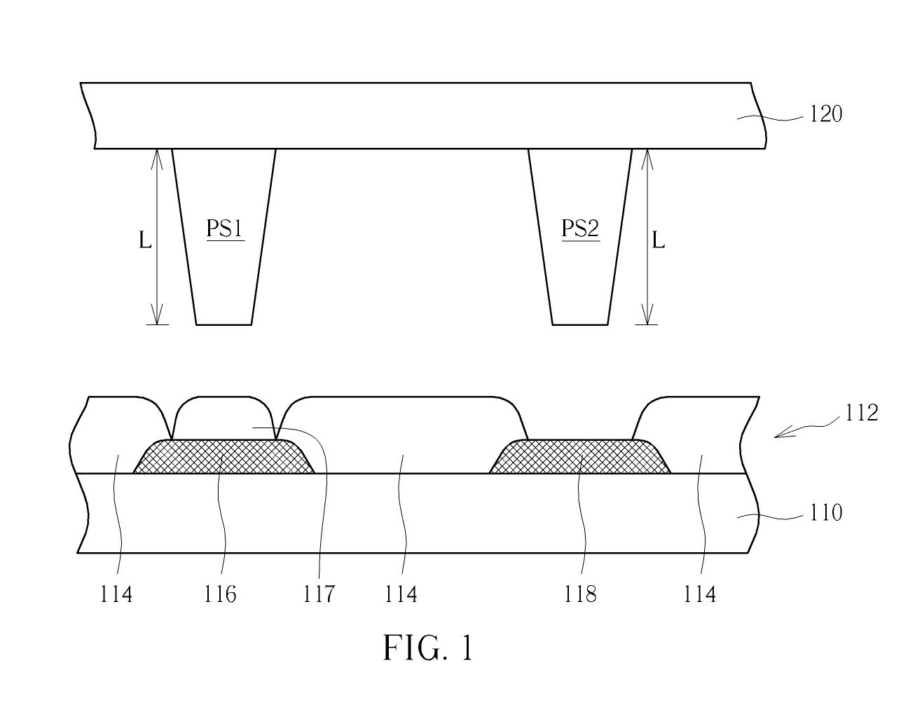

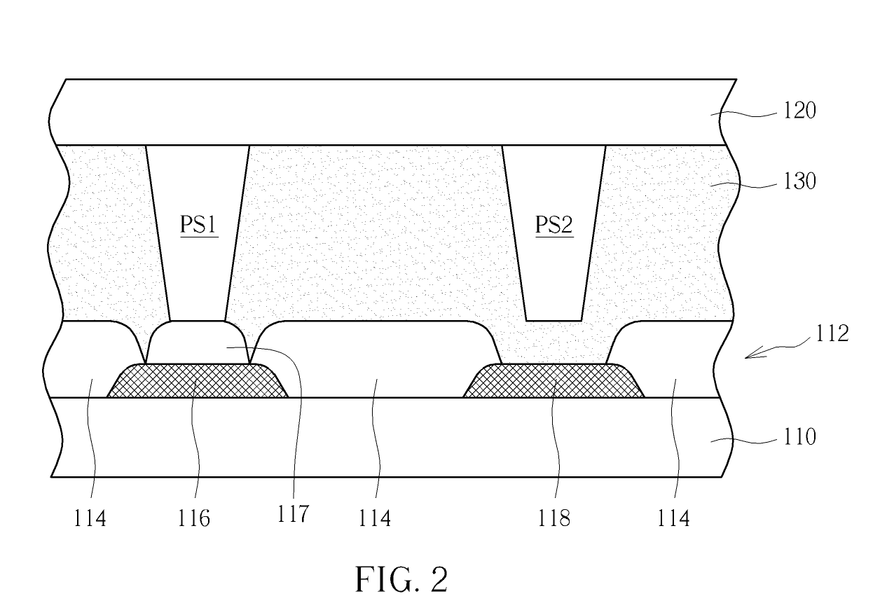

Please refer to FIG. 1 and FIG. 2 together. FIG. 1 is a diagram showing a pixel structure of a liquid crystal display panel of the present invention before assembly. FIG. 2 is a diagram showing a pixel structure of the liquid crystal display panel of the present invention after assembly. As shown in figures, the pixel structure of the liquid crystal display panel of the present invention comprises a first substrate 110 and a second substrate 120. The second substrate 120 is an array substrate, comprising a substrate, a thin film transistor (TFT) array, scan lines, data lines, transparent electrodes, at least one insulator layer, and related components. For simplification, the substrate, the TFT array, scan lines, data lines, transparent electrodes, the at least one insulator layer, and related components are integrated to be shown as the second substrate 120 in the figures. Moreover, the pixel structure comprises at least one thin film transistor of the TFT array. A color filter layer 112 is formed on the first substrate 110. The color filter layer 112 comprises a plurality of filtering areas 114 (such as a red filtering area, a green filtering area, and a blue filtering area), a first blocking area 116 and a second blocking area 118. The filtering areas 114 are configured to filter light. The filtering areas 114 are respectively formed by photoresist materials in different colors. The first blocking area 116 and the second blocking area 118 are configured to block light. A covering layer 117 is further formed on the first blocking area 116. A main spacer PS1 and a sub spacer PS2 are formed on the second substrate 120. The main spacer PS1 is formed at a position on the second substrate 120 corresponding to the first blocking area 116. The sub spacer PS2 is formed at a position on the second substrate 120 corresponding to the second blocking area 118. Lengths L of the main spacer PS1 and the sub spacer PS2 are identical. In the present embodiment, the main spacer PS1 and the sub spacer PS2 are grown from a same horizontal level on the second substrate 120. But in other embodiments of the present invention, the main spacer PS1 and the sub spacer PS2 can be grown from different horizontal levels on the second substrate 120 according to requirements. When the first substrate 110 and the second substrate 120 are combined with each other, the main spacer PS1 contacts the covering layer 117 on the first substrate 110 since the covering layer 117 is formed on the first blocking area 116, such that a supporting force is provided between the first substrate 110 and the second substrate 120. Moreover, a gap is formed between the first substrate 110 and the second substrate 120. As such, a liquid crystal material can be filled into the gap between the first substrate 110 and the second substrate 120, in order to form a liquid crystal layer 130. In addition, since there is no covering layer formed on the second blocking area 118, a gap is formed between the sub spacer PS2 and the second blocking area 118 of the first substrate 110, in order to provide a space for allowing deformation when the first substrate 110 and/or the second substrate 120 are pressed by external forces. After the liquid crystal layer 130 is formed, the thin film transistor formed on the second substrate 120 can apply a bias voltage to the liquid crystal layer 130 for driving liquid crystals to rotate, in order to display images.

According to the above arrangement, lengths of the main spacer PS1 and the sub spacer PS2 of the pixel structure of the liquid crystal display panel of the present invention can be identical, thus a halftone mask process, which makes the sub spacer PS2 shorter than the main spacer PS1, is not required. In other words, the main spacer PS1 and the sup-spacer PS2 can be formed simultaneously in a same manufacturing process by using a regular mask, so as to reduce manufacturing cost and simplify manufacturing processes. Therefore, when the pixel structure of the liquid crystal display panel of the present invention is applied to the manufacturing processes of the liquid crystal display panel, difficulty in product development of the liquid crystal display panel can be decreased.

In addition, in the embodiment of the present invention, the covering layer 117 is formed by at least one photoresist material. For example, during formation of the color filter layer 112, the covering layer 117 and one of the plurality of filtering areas 114 (such as the red, green or blue filtering area) can be formed simultaneously in a same manufacturing process. Thus an additional process for forming the covering layer 117 is not required.

Moreover, in the above embodiment of the present invention, an end of the main spacer PS1 contacts an upper surface of the covering layer 117 on the first substrate 110. However, in other embodiments of the present invention, the end of the main spacer PS1 can be also covered by the covering layer 117 on the first substrate 110, that is to say, the end of the main spacer PS1 can be inserted into the covering layer 117 on the first substrate 110 for providing the supporting force.

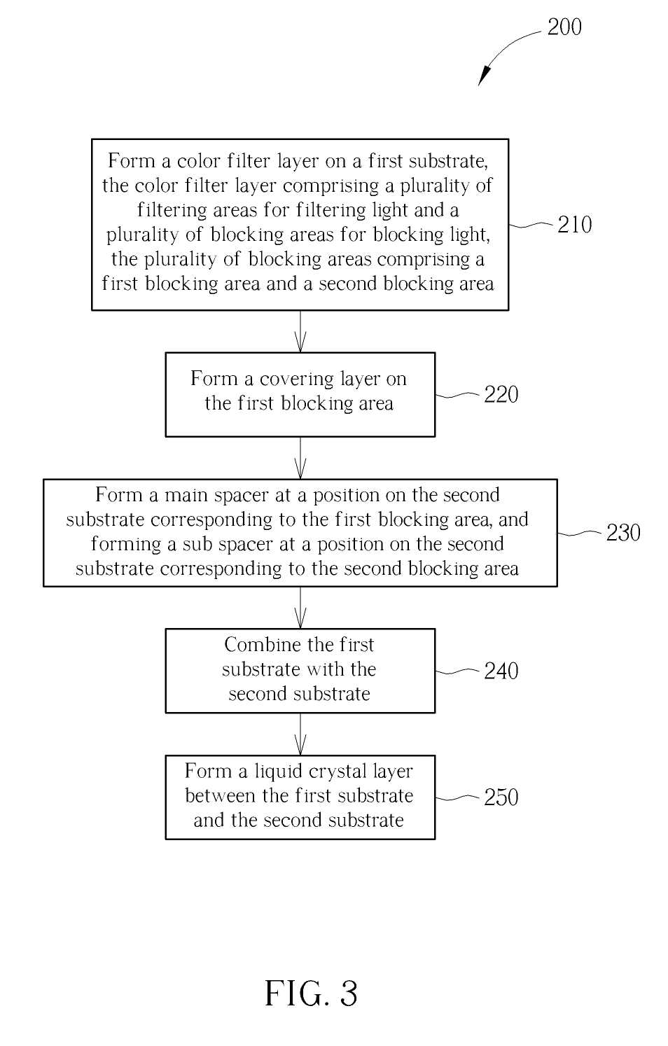

Please refer to FIG. 3. FIG. 3 is a flowchart 200 showing a pixel forming method of the liquid crystal display panel of the present invention. The flowchart of the pixel forming method of the liquid crystal display panel of the present invention comprises the following steps:

Step 210: Forma color filter layer on a first substrate, the color filter layer comprising a plurality of filtering areas for filtering light and a plurality of blocking areas for blocking light, the plurality of blocking areas comprising a first blocking area and a second blocking area;

Step 220: Form a covering layer on the first blocking area;

Step 230: Form a main spacer at a position on the second substrate corresponding to the first blocking area, and forming a sub spacer at a position on the second substrate corresponding to the second blocking area;

Step 240: Combine the first substrate with the second substrate; and

Step 250: Form a liquid crystal layer between the first substrate and the second substrate.

In addition, in the pixel forming method of the present invention, the covering layer and one of the plurality of filtering areas can be formed simultaneously, that is to say, the covering layer is formed by at least one photoresist material. In other words, during formation of the filtering areas in step 210, step 220 for forming the covering layer can be performed simultaneously. Moreover, in step 240, the main spacer and the sub spacer can be formed simultaneously as well, and an end of the main spacer can be covered by the covering layer.

In contrast to the prior art, the lengths of the main spacer PS1 and the sub spacer PS2 of the pixel structure of the liquid crystal display panel of the present invention can be identical, thus the halftone mask process, which makes the sub spacer PS2 shorter than the main spacer PS1, is not required. Therefore, the pixel structure and the pixel forming method of the liquid crystal display panel of the present invention can reduce manufacturing cost and simplify manufacturing processes, so as to further decrease difficulty in product development of the liquid crystal display panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pixel structure of a liquid crystal display panel, comprising:
a first substrate;
a color filter layer formed on the first substrate, the color filter layer comprising:
a plurality of filtering areas for filtering light; and
a plurality of blocking areas for blocking light, the plurality of blocking areas comprising a first blocking area and a second blocking area;
a covering layer formed on the first blocking area;
a second substrate;
a main spacer formed at a position on the second substrate corresponding to the first blocking area; and
a sub spacer formed at a position on the second substrate corresponding to the second blocking area;
wherein an end of the main spacer contacts the covering layer, and a gap is formed between the sub spacer and the second blocking area.

2. The pixel structure of claim 1, wherein lengths of the main spacer and the sub spacer are identical.

3. The pixel structure of claim 1, wherein the covering layer is formed by at least one photoresist material.

4. The pixel structure of claim 1, wherein the end of the main spacer is covered by the covering layer.

5. The pixel structure of claim 1 further comprising a liquid crystal layer arranged between the first substrate and the second substrate.

6. The pixel structure of claim 1, wherein the second substrate is an array substrate.

7. A pixel forming method of a liquid crystal display panel, comprising:
forming a color filter layer on a first substrate, the color filter layer comprising a plurality of filtering areas for filtering light and a plurality of blocking areas for blocking light, the plurality of blocking areas comprising a first blocking area and a second blocking area;
forming a covering layer on the first blocking area;
forming a main spacer at a position on a second substrate corresponding to the first blocking area, and forming a sub spacer at a position on the second substrate corresponding to the second blocking area; and
combining the first substrate with the second substrate;
wherein an end of the main spacer contacts the covering layer, and a gap is formed between the sub spacer and the second blocking area.

8. The pixel forming method of claim 7, wherein the main spacer and the sub spacer are formed simultaneously, and the end of the main spacer is covered by the covering layer.

9. The pixel forming method of claim 7, wherein the covering layer is formed by at least one photoresist material.

10. The pixel forming method of claim 7, wherein the covering layer and one of the plurality of filtering areas are formed simultaneously.

11. The pixel forming method of claim 7 further comprising forming a liquid crystal layer between the first substrate and the second substrate.

12. The pixel forming method of claim 7, wherein the main spacer and the sub spacer are formed in a same manufacturing process.

13. The pixel forming method of claim 7, wherein one of the plurality of the filtering areas and the covering layer are formed in a same manufacturing process.

14. The pixel forming method of claim 7, wherein lengths of the main spacer and the sub spacer are identical.

15. The pixel forming method of claim 7, wherein the second substrate is an array substrate.
